(19) United States
(12) Patent Application Publication
(10) Pub. No.: US 2010/0134880 A1
(43) Pub. Date: Jun. 3, 2010

(54) PROJECTION OBJECTIVE

(75) Inventor: Hans-Juergen Mann, Oberkochen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/687,325

(22) Filed: Jan. 14, 2010

Related U.S. Application Data
(63) Continuation of application No. PCT/EP2008/005569, filed on Jul. 9, 2008.

(30) Foreign Application Priority Data
Jul. 19, 2007 (DE) 102007033967.6

(51) Int. Cl. G02B 17/00

(52) U.S. Cl. 359/364

(57) ABSTRACT

The disclosure relates to a projection objective for imaging an object field in an object plane having a field aspect ration (x/y) of at least 1.5 into an image field in an image plane. In general, the projection objective has at least two optically effective surfaces for guiding imaging light in a beam path between the object field and the image field. The projection objective can take up an installed space having a cuboid envelope that is spanned by a length dimension and two transverse dimensions.

### CROSS-REFERENCE TO RELATED APPLICATION

This application is a continuation of, and claims benefit under 35 USC 120 to, international application PCT/EP2008/005569, filed Jul. 9, 2008, which claims benefit of German Application No. 10 2007 033 967.6, filed Jul. 19, 2007. International application PCT/EP2008/005569 is hereby incorporated by reference in its entirety.

### FIELD

The disclosure relates to a projection objective for imaging an object field in an object plane having a field aspect ratio of at least 1.5 into an image field in an image plane.

### BACKGROUND

Projection objectives are known, for example, from U.S. Pat. No. 4,796,984, U.S. Pat. No. 6,813,098, U.S. Pat. No. 3,748,015 and JP 10 340848 A. Such projection objectives may be used for producing flat panel displays (FPD) or in connection with applying micro-structured semiconductor components onto a base layer (wafer level packaging, WLP).

### SUMMARY

In some embodiments, the disclosure provides a projection objective that can be configured in a relatively compact configuration in at least in one dimension.

In certain embodiments, the disclosure provides a projection objective configured to image an object field in an object plane having a field aspect ratio of at least 1.5 into an image field in an image plane. The projection objective includes at least two optically effective surfaces configured to guide imaging light in a beam path between the object field and the image field. The object field has first and second dimensions that are perpendicular to each other. The first dimension of the object field is less than the second dimension of the object field. The optically effective surfaces, the object field and the image field take up an installed space having a cuboid envelope. The cuboid envelope has a length dimension, a first dimension and a second dimension. The first dimension of the cuboid envelop is transverse to the length dimension of the cuboid envelope, and the second dimension of the cuboid envelope is transverse to the length dimension of the cuboid envelope. The first dimension of the cuboid envelope is perpendicular to the second dimension of the cuboid envelope. The length dimension of the cuboid envelope is a length of the projection objective between the object plane and the image plane. The first dimension of the cuboid envelope is parallel to the first dimension of the object field, and the first dimension of the cuboid envelope is less than the first dimension of the object field.

In some embodiments, the disclosure provides a projection objective configured to image an object field in an object plane having a field aspect ratio of at least 1.5 into an image field in an image plane. The projection objective includes at least two optically effective surfaces configured to guide imaging light in a beam path between the object field and the image field. The optically effective surfaces, the object field and the image field take up an installed space with a cuboid envelope. The projection objective is free of folding mirrors. The cuboid envelope has a length dimension, a first dimension and a second dimension. The length dimension of the cuboid envelope is transverse to the first dimension of the cuboid envelope. The length dimension of the cuboid envelope is transverse to the second dimension of the cuboid envelope. The first dimension of the cuboid envelope is perpendicular to the second dimension of the cuboid envelope. The first dimension of the cuboid envelope is at least 1.1 times greater than the second dimension of the cuboid envelope.

At least one of the optically effective surfaces can be a free-form surface without rotation symmetry.

A ratio of the first dimension of the cuboid envelope to the second dimension of the cuboid envelope can be 1.5 or more (e.g., 2 or more, 2.5 or more, 3 or more, 3.5 or more, 4 or more).

The object field can be rectangular, and the image field can be rectangular.

The projection of objective can have a field aspect ratio of 2 or more (e.g., 5 or more, 10 or more, 25 or more, 40 or more, 50 or more, 60 or more).

The image plane can be arranged at a distance from the object plane, and the object plane can be parallel to the image plane.

The projection objective can be a catoptric projection objective.

The can have an even number of optically effective surfaces (e.g., six optically effective surfaces.

The optically effective surfaces can be mirrors.

The projection objective can have an image scale of 1, and the projection objective can be mirror-symmetric relative to a plane that is centered between the object plane and the image plane.

The projection objective can have a non-zero object image shift (d_{OIS}).

The projection objective can be telecentric on the object side.

The projection objective can be telecentric on the image side.

The term “envelope” used hereinafter is defined as follows: The cuboid envelope represents the smallest possible cuboid installation space, into which the totality of the actually optically effective surfaces of the projection objective, namely those surfaces actually exposed to a useful beam, can be spatially inserted.

The disclosure identified that it is possible to provide dimensions of the projection objective, in which a transverse dimension of the cuboid envelope is smaller than a long dimension of the object field showing an aspect ratio that does not equal 1, without the imaging quality of the projection objective suffering any significant losses. In the direction of this smaller transverse dimension the optically effective surfaces of the projection objectives are closely moved together. In the direction of this smaller transverse dimension axis additional components that interact with the projection objective can be moved close to a central axis of the projection objective. This enhances the structural integrity of an overall system, in which the projection objective is used. Such a projection objective may be accommodated in systems, in which the installed space is limited in one direction. At least individual optically effective surfaces of the projection objective, in particular the largest optically effective surface in terms of its aperture, may be provided with an essentially rectangular aperture, namely with an aperture aspect ratio other than 1. An aperture is understood to mean the optically used area on the optically effective surfaces of the projection objective. The optically effective surfaces of the projection objective may exclusively be such surfaces that not only deflect imaging beams running in the projection objective, but simultaneously have an imaging effect as well. In the projection objective according to the disclosure optical components with smaller optically effective surfaces overall than comparable projection objectives in the prior art may be used. This reduces the weight of the individual optical components, thus avoiding imaging error sources caused by weight. Moreover, the production of such smaller optically effective surfaces can be simplified.

It is possible to provide dimensions of the projection objective that differ significantly with respect to their transverse dimensions. In this context, the envelope—free of folding mirrors—of the projection objective represents the envelope of the projection objective, in which plane folding mirrors are not taken into account. Thus, a beam splitter that uses both light reflected from a reflecting surface as well as light allowed to penetrate the reflecting surface also constitutes a folding mirror regarding this meaning. Hence, a projection objective with such a beam splitter does not constitute a projection objective free of folding mirrors. The envelope of a projection objective having at least one plane folding mirror is thus designed by substituting the projection objective with an equivalent objective without the plane folding mirror and by then determining the envelope of this substitute projection objective. The envelope of the projection objective in accordance with some embodiments can also be a projection objective free of folding mirrors. The projection objective in accordance with certain embodiments may be configured compactly in the direction of the short transverse dimension. A ratio of two dimensions of an object standing perpendicularly on top of one another is always understood below as aspect ratio, always considering the ratio of the longer dimension to the shorter dimension, so that the aspect ratio is always greater than or equal to 1 by definition. The transverse dimension aspect ratio of the previously known projection objectives having components either exactly or approximately arranged around a rotation axis of symmetry is either exactly 1 or close to 1, thus significantly smaller than 1.1. The projection objective according to the disclosure having a transverse dimension aspect ratio of at least 1.1 may be configured compactly in the direction of the short transverse dimension, in each case. In other respects the advantages of the projection objective in accordance with some embodiments correspond to those of the projection objective in accordance with other embodiments.

At least one free-form surface simplifies the design of a projection objective according to the disclosure. Free-form surfaces are for example known from US 2007/0058269 A1. A decrease in imaging quality in comparison to a conventional design having an aperture aspect ratio of 1 can virtually entirely be avoided.

Appropriate transverse dimension aspect ratios allow for a particularly large compactness of the projection objective in the direction of the short aperture axis, in each case.

Appropriate rectangular fields have been well adapted to the typical applications of such projection objectives, in particular to the FPD and WLP applications. Alternatively to rectangular fields, fields also limited in a different way at the edges having a field aspect ratio of at least 1.5 are possible, for example curved or ring-segment-shaped fields.

Appropriate field aspect ratios that may be utilized in connection with a scanning projection having a scanning direction alongside the short field axis are especially well adapted to particularly the FPD and WLP applications. In particular, configurations of the projection objective in accordance with some embodiments are possible, in which the projection objective uses less installed space in a perpendicular position relative to a plane, which is spanned by the two long dimensions of the object field and the image field, than the object field is extended alongside the long field dimension. Hence, the projection objective may be configured especially compact in a perpendicular position relative to the plane spanned by the two long field dimensions.

An image plane arranged at a distance from the object plane allows for an embodiment of the projection objective without a folding mirror, thereby increasing the compactness of the projection objective again.

One catoptric design of the projection objective is wide-banded. With transverse aspect ratios of at least 1.1 small incident angles can be realized on the mirrors of the catoptric projection objective, at least in the main plane, which includes the short side of this aperture aspect ratio. This leads to the possibility of using highly efficient, highly reflective coatings for the mirror surfaces of the catoptric projection objective.

An even number of mirrors usually forces a separation of object field and image field. Moreover, in that case it is not necessary to provide for an aperture diaphragm or stop on or directly in front of a mirror.

Six mirrors in accordance for a projection objective that is simultaneously compact and displays good image quality.

A mirror-symmetric projection objective offers advantages in terms of technical production.

A projection objective may be adapted to corresponding desired structural properties in terms of components surrounding the projection objective. In that case, the object field and the image field do not necessarily have to be aligned.

A telecentric projection objective reduces constraints in terms of the positional accuracy of the distance of an object to the first optically effective surface of the projection objective or the distance of an image element, on which the imaging shall take place, to the last optically effective surface of the projection objective.

### BRIEF DESCRIPTION OF THE DRAWINGS

Exemplary embodiments are described in detail below based on the figures, in which

FIG. 1 shows a sectional drawing of a projection objective in a y-z plane containing selected imaging beams;

FIG. 2 shows a sectional drawing of the projection objective according to FIG. 1 in an x-z plane containing selected imaging beams;

FIG. 3 shows a diagram illustrating the field profile of the wave front over an image field of the projection objective according to FIG. 1; and

FIG. 4 shows a diagram similar to FIG. 3 illustrating the field profile of the distortion over the image field of the projection objective.

### DETAILED DESCRIPTION

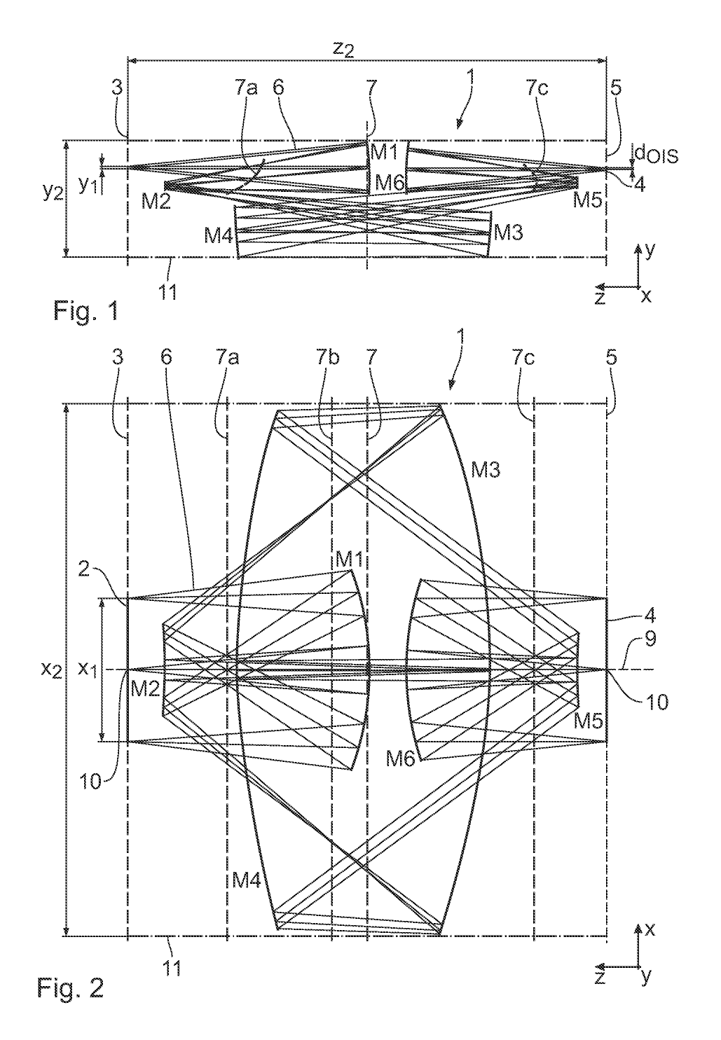

To clarify the relative positions a Cartesian x-y-z coordinate system will be used below. In FIG. 1 the x-direction is facing the viewer perpendicular to the plane of projection. The y-direction is pointing up and the z-direction is facing to the left.

FIG. 1 shows an a y-z sectional drawing of a projection objective 1 for imaging an object field 2 in an object plane 3 into an image field 4 in an image plane 5. The object plane 3 runs parallel to the image plane 5 and is arranged at a distance from the latter. The distance between the object plane 3 and the image plane 5 is 1,600 mm.

FIG. 2 shows the projection objective 1 in an x-z sectional drawing.

The object field 2 and the image field 4 are equal in size. Thus, the projection objective 1 has an image scale of 1. On the object side and on the image side the projection objective 1 has a numeric aperture NA of 0.1. In the x-direction the fields 2, 4 extend 480 mm. In the y-direction the fields 2, 4 extend 8 mm. The fields 2, 4 are rectangular and each have an extension x1 of 480 mm in the x-direction and an extension y1 of 8 mm in the y-direction, thus a field-aspect ratio (x/y) of 60.

The projection objective 1 is designed in a catoptric manner and has a total of six mirrors identified below as M1 to M6 in the order imaging beams impact from the object field 2 to the image field 4. The projection objective 1 thus has an even number of mirrors.

As an example of the imaging beams through the projection objective 1 FIG. 1 shows two triples of imaging beams 6, each of which originate from a field point. Imaging beams adjacent and belonging to one of the two field points in each case run in parallel relative to one another between the object plane 3 and the first mirror M1 and the last mirror M6 and the image plane 4. Thus, on the object side and on the image side the projection objective 1 is telecentric.

Relative to an x-y center plane 7, positioned in center between the object plane 3 and the image plane 5, the projection objective 1 is not embodied in a mirror-symmetric manner.

The projection objective 1 has a finite object image shift d_{OIS}, namely a distance between the piercing point of a normal through the central object field point through the image plane 5 to the central image field point. This object image shift of the projection objective 1 amounts to 6.6 mm.

The imaging beams 6 that belong to various object field points intersect between the mirrors M1 and M2. Thus, an internal pupil 7a of the projection objective 1 is located between the mirrors M1 and M2, the pupil lying on a curved surface. The imaging beams 6 that belong to the same object field points intersect between the mirrors M2 and M3. Hence, an intermediate image of the projection objective 1 is positioned there. A corresponding intermediate image plane 7b is also positioned on a curved surface. The imaging beams 6 that belong to various object field points once again intersect between the mirrors M5 and M6. Consequently, an additional internal pupil 7c of the projection objective 1 is present there, which is also positioned on top of a curved surface. Due to the image scale of 1:1 the objective may also be operated in the opposite light direction. Thus, in this case, the object plane 3 and the image plane 5 switch roles.

The optically effective, reflecting surfaces of the mirrors M1 to M6 are embodied as free-form surfaces without a rotation symmetry axis. Rising heights Z may be specified as a function of the distance r²=X²+Y² for the optically effective surfaces of the mirrors M1 to M6 in accordance with the following formula:

$$\begin{matrix}Z = \frac{{cr}^{2}}{1 + \sqrt{1 - ( 1 + k ) {c}^{2} {r}^{2}}} + {\sum }_{j = 2}^{α} {C}_{j} {X}^{m} {Y}^{n} \\ with & ( 1 ) \\ j = \frac{{( m + n )}^{2} + m + 3 {n}^{25}}{2} + 1 & ( 2 )\end{matrix}$$

Several tables are listed below specifying the optical data of the form and the position of the optically effective surfaces M1 to M6. This data corresponds to the format of the optical ray tracing program Code V®.

TABLE 1

| Surface | Radius | Thickness | Mode of operation |
|---|---|---|---|
| Object | Infinite | 794.924 | |
| Mirror 1 | −633.179 | −694.924 | REFL |
| Mirror 2 | −447.911 | 1,117.315 | REFL |
| Mirror 3 | −1,751.552 | −858.739 | REFL |
| Mirror 4 | 1,952.900 | 1,143.434 | REFL |
| Mirror 5 | 359.756 | −507.086 | REFL |
| Mirror 6 | 627.528 | 605.076 | REFL |
| Image | Infinite | 0.000 | |

TABLE 2

| Coefficient | M1 | M2 | M3 | M4 | M5 | M6 |
|---|---|---|---|---|---|---|
| K | −5.818400E−01 | 3.570572E−01 | −1.722845E−00 | −5.533387E−01 | −3.933652E−01 | −3.907080E−01 |
| Y | 0.000000E−00 | 0.000000E+00 | 0.000000E+00 | 0.000000E+00 | 0.000000E+00 | 0.000000E+00 |
| X2 | 2.591113E−04 | 7.936708E−04 | 7.522336E−05 | −6.813539E−05 | −1.125174E−03 | −2.399132E−04 |
| Y2 | 1.664388E−04 | −4.393373E−04 | 3.575707E−05 | −8.369642E−05 | 6.249251E−04 | −6.233788E−05 |
| X2Y | 2.541958E−08 | −1.159414E−07 | 4.007329E−09 | 2.060613E−09 | 4.643695E−07 | −1.074946E−08 |
| Y3 | −1.454588E−08 | 2.256084E−06 | −3.214846E−08 | −1.794278E−08 | −4.863517E−06 | 1.233397E−07 |
| X4 | 4.447933E−11 | 1.439968E−09 | −2.031918E−11 | −1.226414E−11 | −1.205341E−09 | −1.200919E−10 |
| X2Y2 | −1.962227E−11 | 1.876320E−08 | 1.124049E−11 | 4.900094E−11 | 1.416431E−09 | −2.618665E−10 |
| Y4 | −2.620538E−11 | −2.585786-08 | 2.980775E−10 | 4.785589E−11 | 3.622102E−09 | 4.278076E−10 |
| X4Y | 1.224504E−15 | 8.058907E−12 | −3.295990E−15 | −3.994639E−15 | 1.737583E−13 | 5.337611E−14 |
| X2Y3 | 6.696668E−14 | −1.240693E−10 | 4.510894E−13 | 5.239312E−13 | −1.607982E−11 | −1.030709E−12 |
| Y5 | −2.088416E−13 | 9.965347E−11 | 1.278004E−12 | −8.957047E−13 | 3.140773E−10 | 2.724635E−13 |
| X6 | 2.439707E−18 | −5.426596E−15 | 9.920133E−19 | −1.038339E−18 | −2.390404E−15 | −5.217553E−17 |
| X4Y2 | 9.419434E−17 | −5.333909E−14 | −1.884151E−17 | −3.242336E−17 | −5.653132E−15 | 7.224733E−16 |
| X2Y4 | −3.935167-16 | 3.792500E−13 | 1.747077E−15 | 1.854305E−15 | 2.679660E−13 | −1.394217E−15 |
| Y6 | 4.905517E−16 | −5.522675E−13 | 2.936376E−15 | −4.674654E−15 | −3.821649E−12 | −7.964719E−16 |
| X6Y | 1.179799E−19 | 1.543683E−16 | −5.845978E−22 | −6.199825E−22 | 2.156843-17 | 3.990811E−19 |
| X4Y3 | −3.920794E−19 | −3.609249E−16 | −6.826279E−20 | −8.326937E−20 | −2.413603E−16 | 3.058263E−18 |
| X2Y5 | 1.767166E−19 | −2.869144E−15 | 3.438749E−18 | 3.287773E−18 | 1.413442E−15 | 9.920212E−19 |
| Y7 | −9.897840E−19 | −4.691690E−16 | 3.665879E−18 | −9.226327E−18 | 7.667025E−14 | −1.821128E−18 |
| X8 | −4.183794E−23 | 3.395472E−20 | −4.773630E−25 | −2.918876E−25 | −1.063758E−21 | −1.409741E−22 |
| X6Y2 | −4.548378E−22 | −2.964584E−19 | −3.576166E−24 | −2.804184E−24 | 3.651898E−19 | 6.378310E−22 |
| X4Y4 | −2.974316E−22 | 3.923714E−18 | −9.069379-23 | −9.865968E−23 | −1.550636E−17 | 4.455191E−21 |
| X2Y6 | −5.225037E−22 | 1.302143E−17 | 2.734568E−21 | 2.337779E−21 | 2.493989E−16 | 4.361250E−21 |
| Y8 | 7.963684E−22 | 1.212175E−17 | 1.420827E−21 | −7.030701E−21 | −2.297185E−15 | −2.427002E−22 |
| X8Y | 0.000000E+00 | 0.000000E+00 | 0.000000E+00 | 0.000000E+00 | 0.000000E+00 | 0.000000E+00 |
| X6Y3 | 0.000000E+00 | 0.000000E+00 | 0.000000E+00 | 0.000000E+00 | 0.000000E+00 | 0.000000E+00 |
| X4Y5 | 0.000000E+00 | 0.000000E+00 | 0.000000E+00 | 0.000000E+00 | 0.000000E+00 | 0.000000E+00 |
| X2Y7 | 0.000000E+00 | 0.000000E+00 | 0.000000E+00 | 0.000000E+00 | 0.000000E+00 | 0.000000E+00 |
| Y9 | 0.000000E+00 | 0.000000E+00 | 0.000000E+00 | 0.000000E+00 | 0.000000E+00 | 0.000000E+00 |
| X10 | 0.000000E+00 | 0.000000E+00 | 0.000000E+00 | 0.000000E+00 | 0.000000E+00 | 0.000000E+00 |
| X8Y2 | 0.000000E+00 | 0.000000E+00 | 0.000000E+00 | 0.000000E+00 | 0.000000E+00 | 0.000000E+00 |
| X6Y4 | 0.000000E+00 | 0.000000E+00 | 0.000000E+00 | 0.000000E+00 | 0.000000E+00 | 0.000000E+00 |
| X4Y6 | 0.000000E+00 | 0.000000E+00 | 0.000000E+00 | 0.000000E+00 | 0.000000E+00 | 0.000000E+00 |
| X2Y8 | 0.000000E+00 | 0.000000E+00 | 0.000000E+00 | 0.000000E+00 | 0.000000E+00 | 0.000000E+00 |
| Y10 | 0.000000E+00 | 0.000000E+00 | 0.000000E+00 | 0.000000E+00 | 0.000000E+00 | 0.000000E+00 |
| Nradius | 1.000000E+00 | 1.000000E+00 | 1.000000E+00 | 1.000000E+00 | 1.000000E+00 | 1.000000E+00 |

TABLE 3

| Coefficient | M1 | M2 | M3 | M4 | M5 | M6 |
|---|---|---|---|---|---|---|
| Y-Decentration | −141.284 | −130.461 | 24.163 | 52.036 | −11.639 | 298.294 |
| X-rotation | −10.538 | −22.106 | 0.898 | −1.106 | 1.96 | −24.756 |

Table 1 includes the base radiuses R=1/c (radius) and the relative distances (thickness) of the mirrors relative to one another, starting from the image plane 5 (image, thickness=0). Table 2 includes the polynomial coefficients C to the mononomials X^{m}Yⁿ in accordance with the surface description of a SPS XYP—(special surface x-y-polynomial) surface in Code V®. Table 3 includes y-decentrations and rotations of the optically effective surfaces around the x-axis in accordance with the sign convention from Code V®. x-decentrations and rotations around the y-axis as well as polynomial coefficients with an uneven power of x equal zero. This forces a mirror symmetry of the system around a y-z center plane 9 (cf. FIG. 2). Hence, with respect to the y-z center plane 9 the projection objective 1 is mirror-symmetric.

From the basic structure the design of the projection objective 1 approximates a design that is mirror-symmetric to the x-y center plane 7. The first mirrors M1 to M3—viewed from the object field 2—each have a counterpart M4 to M6—viewed from the image field 4. The apertures and the positions of the mirror pairs M1/M6, M2/M5 and M3/M4 resemble each other, projected on the x-y center plane 7.

FIG. 2 shows the imaging beams 6 in the x-z plane to three selected field points, with a triple of imaging beams 6 in turn shown for each field points. A lowest field point 10 in FIG. 2, in each case, is the central object or image field point of the projection objective 1.

The mirrors M1 to M6 have an aperture aspect ratio x/y, each of which is unequal 1. The mirrors M1 to M6 each have an essentially rectangular aperture, with the extension of the aperture being significantly greater in the direction of the long field axis x than in the direction of the short field axis y. The precise aperture aspect ratios of the mirrors M1 to M6 are shown in the table below:

| | Aperture in x-direction | Aperture in y-direction | Aperture |
|---|---|---|---|
| Mirror | [mm] | [mm] | aspect ratio x/y |
| M1 | 666 | 166 | 4.0 |
| M2 | 306 | 22 | 13.9 |
| M3 | 1765 | 146 | 12.1 |
| M4 | 1731 | 166 | 10.4 |
| M5 | 249 | 34 | 7.3 |
| M6 | 604 | 131 | 4.6 |

The maximum angle of incidence of one the imaging beams 6 onto one of the mirrors M1 to M6 occurs in the x-z plane (mirror M2) and amounts to approximately 38.2°.

The maximum angle of incidence of the imaging beams running within the y-z symmetry plane (meridional plane) onto a mirror M1 to M6 amounts to 12.3° (mirror M2).

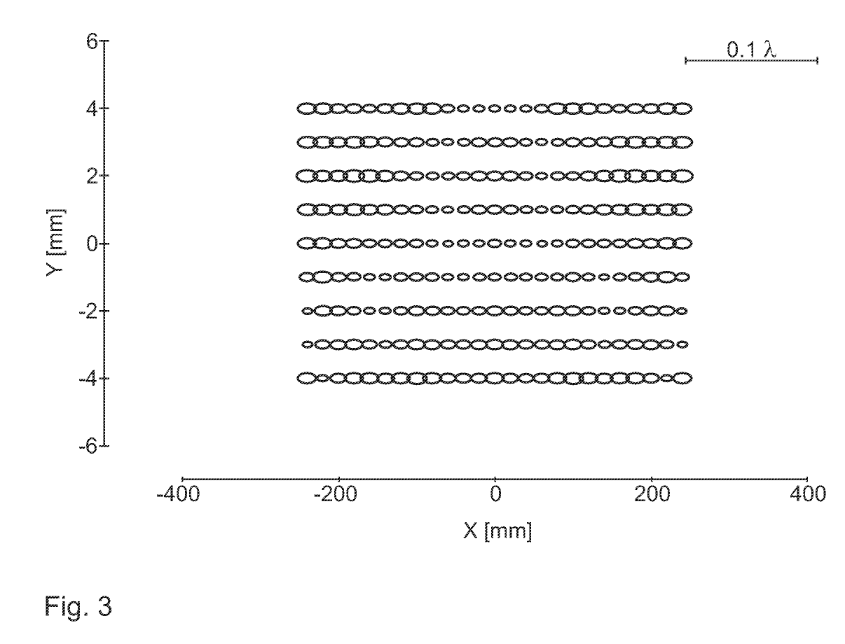

FIG. 3 shows the field profile of the wave front over the image field 4. The different scales of the x-axis and y-axis are pointed out in this connection. The correction of the wave front lies below an RMS value of 17 mλ. With a working wavelength of imaging light of 365 nm this corresponds to an RMS value of 6 nm.

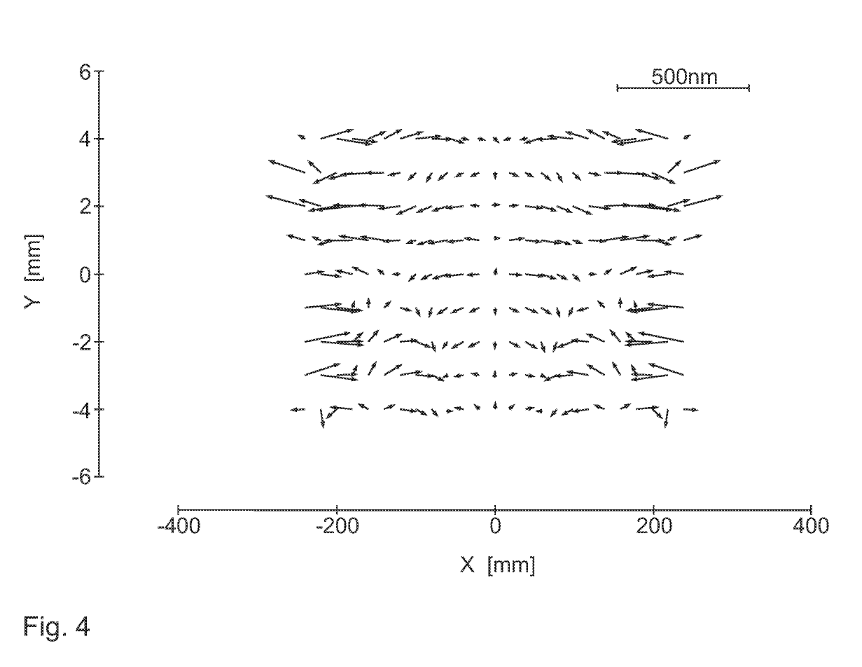

FIG. 4 shows a distortion over the image field 4. The maximum value of the distortion over the field is approximately 170 nm.

The optically effective surfaces M1 to M6 of the projection objective 1 take up an installed space that can be written in a cuboid envelope 11. The six lateral surfaces of the envelope 11 run in pairs in parallel to the x-y plane, to the x-z plane and to the y-z plane. The lateral surface pair of the envelope 11 that runs in parallel to the x-y plane coincides with the object plane 3 and the image plane 5. The other two lateral surface pairs have been illustrated in FIG. 1 and in FIG. 2 by means of a dot and dash line.

The envelope 11 is spanned by a length dimension (z2) in z-direction and by two transverse dimensions (x2, y2) in x and y-direction. The length dimension (z2) of the envelope 11 is determined by the length of the projection objective 1 between the object plane 3 and the image plane 5 and amounts to 1,600 mm. The transverse dimension (x2) of the envelope 11 is determined by the maximum x-dimension of the greatest optically effective surface, thus by the aperture of the mirror M3 in the x-direction, amounting to 1,765 mm. The transverse dimension (y2) of the envelope 11 is much lower than the x-transverse dimension and amounts to 380 mm. One transverse dimension aspect ratio between the x-transverse dimension and the y-transverse dimension is thus greater than 4.6. The extension of the projection objective 1 in the y-direction (y2=380 mm) is smaller than the field extension in the x-direction (x1=480 mm).

Other embodiments of corresponding projection objectives not shown here may also have different transverse dimension aspect ratios between the x-transverse dimension and the y-transverse dimension, for example a transverse dimension aspect ratio of 1.5 or more, of 2 or more, of 2.5 or more, of 3 or more, or of 4 or more.

In one embodiment—not shown here—the projection objective is designed in a mirror-symmetric manner relative to the x-y center plane 7.

What is claimed is:

1. A projection objective configured to image an object field in an object plane having a field aspect ratio of at least 1.5 into an image field in an image plane, the projection objective comprising:
at least two optically effective surfaces configured to guide imaging light in a beam path between the object field and the image field,
wherein:
the object field has first and second dimensions that are perpendicular to each other;
the first dimension of the object field is less than the second dimension of the object field;
the optically effective surfaces, the object field and the image field take up an installed space having a cuboid envelope;
the cuboid envelope has a length dimension, a first dimension and a second dimension;
the first dimension of the cuboid envelope is transverse to the length dimension of the cuboid envelope;
the second dimension of the cuboid envelope is transverse to the length dimension of the cuboid envelope;
the first dimension of the cuboid envelope is perpendicular to the second dimension of the cuboid envelope;
the length dimension of the cuboid envelope is a length of the projection objective between the object plane and the image plane;
the first dimension of the cuboid envelope is parallel to the first dimension of the object field; and
the first dimension of the cuboid envelope is less than the first dimension of the object field.

2. A projection objective configured to image an object field in an object plane having a field aspect ratio of at least 1.5 into an image field in an image plane, the projection objective comprising:
at least two optically effective surfaces configured to guide imaging light in a beam path between the object field and the image field,
wherein:
the optically effective surfaces, the object field and the image field take up an installed space with a cuboid envelope;
the cuboid envelope is free of folding mirrors;
the cuboid envelope has a length dimension, a first dimension and a second dimension;
the length dimension of the cuboid envelope is transverse to the first dimension of the cuboid envelope;
the length dimension of the cuboid envelope is transverse to the second dimension of the cuboid envelope;
the first dimension of the cuboid envelope is perpendicular to the second dimension of the cuboid envelope;
the first dimension of the cuboid envelope is at least 1.1 times greater than the second dimension of the cuboid envelope.

3. The projection objective of claim 1, wherein at least one of the optically effective surfaces is a free-form surface without rotation symmetry.

4. The projection objective of claim 1, wherein a ratio of the first dimension of the cuboid envelope to the second dimension of the cuboid envelope can be 1.5 or more.

5. The projection objective of claim 1, wherein the object field is rectangular, and the image field is rectangular.

6. The projection objective of claim 1, wherein projection objective can have a field aspect ratio of 2 or more.

7. The projection objective of claim 1, wherein the image plane is arranged at a distance from the object plane, and the object plane is parallel to the image plane.

8. The projection objective of claim 1, wherein the projection objective is a catoptric projection objective.

9. The projection objective of claim 1, wherein the projection objective has an even number of optically effective surfaces.

10. The projection objective of claim 9, wherein the projection objective has six optically effective surfaces.

11. The projection objective of claim 1, wherein the optically effective surfaces are mirrors.

12. The projection objective of claim 11, wherein the projection objective has an even number of mirrors.

13. The projection objective of claim 12, wherein the projection objective has six mirrors.

14. The projection objective of claim 1, wherein the projection objective has an image scale of 1, and the projection objective is mirror-symmetric relative to a plane that is centered between the object plane and the image plane.

15. The projection objective of claim 1, wherein the projection objective has a non-zero object image shift (d_{OIS}).

16. The projection objective of claim 1, wherein the projection objective is telecentric on the object side.

17. The projection objective of claim 1, wherein the projection objective is telecentric on the image side.

18. The projection of objective of claim 1, wherein the projection objective is configured to be used in applying micro-structured semiconductor components onto a base layer.

19. The projection objective of claim 1, wherein projection objective can have a field aspect ratio of 5 or more.

20. The projection objective of claim 2, wherein the projection objective is configured to be used in applying micro-structured semiconductor components onto a base layer.
